(19) United States
(12) Patent Application Publication
(10) Pub. No.: US 2004/0114519 A1
(43) Pub. Date: Jun. 17, 2004

(54) Network bandwidth anomaly detector apparatus, method, signals and medium

(76) Inventor: Gary Lorne MacIsaac, Vancouver (CA)

Correspondence Address: DOWELL & DOWELL PC, SUITE 309, 1215 JEFFERSON DAVIS HIGHWAY, ARLINGTON, VA, 22202

(21) Appl. No.: 10/722,423

(22) Filed: Nov. 28, 2003

Related U.S. Application Data
(60) Provisional application No. 60/433,032, filed on Dec. 13, 2002.

(30) Foreign Application Priority Data
May 15, 2003 (WO) PCT/CA03/00724

(51) Int. Cl. H04L 1/00

(52) U.S. Cl. 370/232

(57) ABSTRACT

A method of detecting bandwidth anomalies in a communication system involves receiving a first traffic waveform representing a time distribution of data volume in a first direction in the data communication system in a first period of time, producing a correlation value representing a correlation of the first traffic waveform with a reference waveform, and producing a bandwidth anomaly signal when the correlation value satisfies a criterion.

### BACKGROUND OF THE INVENTION

1. Field of Invention

This invention relates generally to computer networks and security, network bandwidth abuse associated with Distributed Denial of Service attacks and more particularly to a network bandwidth anomaly detector apparatus, method, signals and medium.

2. Description of Related Art

The rapid expansion of high-speed personal Internet connections and the use of the World Wide Web for commerce, entertainment and education provides significant benefits to the global user community. The wide-spread, low cost and continuous availability of web-based information services has resulted in developments ranging from new business models to portals which provide access to government and education services, to the rapid and free exchange of ideas and information for all members of the Internet community.

Because the Internet is so widely available to the public it is vulnerable to being disrupted by various malicious exploits of network protocol behaviours which are fundamental to the operation of the Internet. The malicious exploits include the creation and dissemination of rapidly propagating computer viruses which target particular operating systems or applications, abuses of network protocol features such as packet broadcasting and TCP/IP connection establishment, and intrusions into network-connected computer systems.

The perpetrators of such malicious exploits often take advantage of computer operating system flaws and basic human errors in system configuration such as poor choices for access control passwords. System administrators and users can attempt to minimize the vulnerabilities of their computer systems by changing procedures, applying software patches, and the like. It is inevitable that software bugs will continue to appear, user configuration errors will be made and attackers will uncover previously unknown weaknesses in systems or will modify current attack software in new ways.

Even secure computer systems are vulnerable to having their Internet connectivity disrupted. One type of malicious Internet activity, which can produce significant disruption to users of Internet web sites, Domain Name Servers and/or core routers, includes the so-called “distributed denial of service” (DDoS) attack. These attacks are very difficult to defend against because they make use of functions which are fundamental to the operation of the Internet itself.

DDoS attacks are characterized by the compromise of many different computer systems, often scattered across the Internet, along with the installation of drone software agents on the compromised computers. The compromised attacking systems may number in the tens, hundreds or even thousands of computers. The drone software agents cause each of the compromised computers to launch a coordinated flood of packets. The packets are all addressed to a selected target system. The packets may comprise, for example, continuous streams of Transmission Control Protocol (TCP), User Datagram Protocol (UDP) and/or Internet Control Message Protocol (ICMP) packets all directed at the target system. These protocols are implemented at the Internet layer and the transport layer which are described in Internet Engineering Task Force (“IETF”) RFC Standard 1122 and related RFC documents.

Dealing with the incoming packets generated by the compromised computer system consumes so much of the resources of the target computer system that it is incapable of servicing normal requests. Often a denial of service attack of this type can last for an extended period of time making a target server unavailable for the duration of the attack. Further, the flood of packets all addressed to a target system can overload the packet processing capability of routers located near the target system. Thus a distributed denial of service attack can affect users of computer systems which are not directly targeted by the attack.

DDoS attacks are very difficult to trace to their source. In almost all cases, the source Internet Protocol (IP) addresses found in the flooding packets have been spoofed, that is altered to a false value, thereby providing no information about the true identity of the originating systems.

A detailed description of the software agents used in distributed denial of service attacks can be found at the Computer Emergency Response Team web site operated by the Carnegie-Mellon University Software Engineering Institute, “CERT Advisory CA-2000-0 1 Denial-of-Service Developments”.

There exist some systems which may provide some means for identifying signatures of known drone agents and/or limiting the ability of drones to spoof the source address of packets used in attacks. Packet filtering firewalls such as described, for example, in U.S. Pat. No. 5,606,668 issued Feb. 25, 1997 and entitled “System for Securing Inbound and Outbound Data Packet Flow in a Computer Network”, can be used to block certain packets before they reach a particular computer or network. A packet filtering firewall inspects the contents of the header of each packet received at the firewall and applies a set of rules to determine what should be done with the packet. As more rules are applied to the firewall, performance suffers and firewall maintenance increases. However, a packet filtering firewall does not provide an effective defense against a DDoS attack because the firewall itself can become overwhelmed by the incoming packets.

Intrusion detection systems can be used to determine when a computer system is being comprised. U.S. Pat. No. 6,088,804 entitled “Adaptive System and Method for Responding to Computer Network Security Attacks”, describes one such system which uses agents and adaptive neural network technology to learn simulated attack signatures (e.g. virus patterns). A disadvantage of this system is that real attack signatures may not be similar to the simulated signatures and new signatures for which no training has been carried out may go completely undetected. Another system described in U.S. Pat. No. 5,892,903 entitled “Method and Apparatus for Detecting and Identifying Security Vulnerabilities in an Open Network Computer Communication System”, tests computers and network components for known vulnerabilities and provides reports for action by network management staff. However, this system requires a database of known vulnerabilities and detailed computer-system-specific descriptions of vulnerable components. Furthermore, these prior art system implementations depend upon operating system specific and packet content specific information to identify attack signatures on compromised computers. A summary of intrusion detection systems is described in the paper by Debar, et al (1999), Towards a Taxonomy of Intrusion-Detection Systems, Computer Networks 31: 805-822.

There will always be Internet computer systems which are vulnerable to being compromised and which can be used to launch DDoS attacks against other computer systems. In this constantly evolving environment, intrusion detection systems will naturally lag in detection capabilities. Encryption techniques and other stealth methods are routinely used by attack perpetrators to avoid detection of drone agents and the interception of communications between the malicious user, the master agents and the drone agents.

There is currently no easy method to discover the path from the target of an attack to the sources of the attack. Locating the source systems is a time-consuming process involving the detailed examination of system and router logs and extensive human communication and cooperation among the affected parties to exchange evidence. One system which attempts to address this issue is described in WO/01/46807. However, this system requires significant changes to router software and automated access to routers belonging to multiple Internet Service Providers (ISPs). This level of access is unlikely between competing ISPs.

Prior art in the field of network security and intrusion detection has focussed on examination of packet contents and higher level protocol analysis (for example, TCP layer connection handshaking and flow identification) to detect abnormal network data traffic. These systems and methods involve careful examination of all packets traversing a data link and require significant processing and memory resources as well as more complex configuration by network management personnel.

Current methods focus on protecting the targets of DDoS attacks or the ISP core routers. The above methods fail to quickly detect the onset of malicious bandwidth consumption adjacent to the source and are not capable of immediately detecting abnormal changes in network traffic, in an automatic or user controlled manner, which is independent of the upper layer network protocols used to mount the attack.

### SUMMARY OF THE INVENTION

The present invention addresses the above problem by providing a method of detecting bandwidth anomalies in a data communication system. The method is capable of detecting bandwidth anomalies of the type that occur as a result of a Distributed Denial of Service Attack on a network, for example, but may be used to detect other bandwidth anomalies. In a very basic form, the method involves receiving a first traffic waveform representing a time distribution of data volume in a first direction in the data communication system in a first period of time, producing a correlation value representing a correlation of the first traffic waveform with a reference waveform, and producing a bandwidth anomaly signal when the correlation value satisfies a criterion.

Producing a bandwidth anomaly signal may involve producing the bandwidth anomaly signal when the correlation value is less than a reference value. Producing a bandwidth anomaly signal may involve determining whether the correlation value is less than the reference value.

The method may involve generating the first traffic waveform in response to a first set of traffic measurement values. Generating the first traffic waveform may involve subjecting the first set of traffic measurement values to a Discrete Wavelet Transform. Haar wavelet filter coefficients may be used in the Discrete Wavelet Transform. The Discrete Wavelet Transform may produce a first component representing the first traffic waveform. Producing the correlation value may involve correlating the first component with the reference waveform.

A processor circuit may be used to generate the first traffic waveform and to correlate the first traffic waveform with the reference waveform.

The method may further include monitoring data in the first direction and producing the first set of traffic measurement values in response thereto.

Producing the first set of traffic measurement values may involve producing values representing a property of an Ethernet statistics group in a remote monitoring protocol.

A processor circuit may be used to produce the first traffic waveform and to communicate with a communication interface to receive the values representing the property of an Ethernet statistics group.

Monitoring data in the first direction may involve at least one of: counting packets and counting octets, in the first direction.

A processor circuit operable to produce the first traffic waveform may be configured to communicate with at least one of a packet counter and an octet counter to receive values representing the first set of traffic measurement values. The processor circuit may be configured to implement the packet counter and/or the octet counter.

The method may further involve passively monitoring the data in the first direction.

The method may further involve transmitting and receiving data from a data communication system and signaling an operator in response to the bandwidth anomaly signal.

The method may further involve controlling at least one of transmission and reception of data from the network in response to the bandwidth anomaly signal.

The method may further involve receiving a second traffic waveform representing a time distribution of data volume in a second direction on the data communication system in a second period of time, and using the second traffic waveform as the reference waveform to produce the correlation value.

The method may involve generating the first and second traffic waveforms in response to first and second sets of traffic measurement values, representing traffic in first and second directions on the network, respectively.

Generating the first and second traffic waveforms may involve subjecting the first and second sets of traffic measurement values respectively, to a Discrete Wavelet Transform. Haar wavelet filter coefficients may be used in the Discrete Wavelet Transform. The Discrete Wavelet Transform may produce a first component, representing the first traffic waveform and a second component, representing the second traffic waveform. Producing the correlation value may comprise correlating the first and second components.

The method may involve implementing the traffic waveform generator in a processor circuit used to produce the correlation value.

The method may involve monitoring data in the first and second directions and producing the first and second sets of traffic measurement values respectively in response thereto.

Producing traffic measurement values may involve producing values representing a property of an Ethernet statistics group in a remote monitoring protocol, for each of the first and second directions.

The method may involve causing a processor circuit operable to produce the first and second traffic waveforms to communicate with a communication interface to receive the values representing a property of an Ethernet statistics group.

Monitoring may involve counting at least one of packets and octets in each of the first and second directions.

The method may involve causing a processor circuit operable to produce the first and second traffic waveforms to communicate with a packet counter and/or an octet counter to receive values representing the first and second sets of traffic measurement values.

The method may involve causing the processor circuit to implement at least one of the packet counter and the octet counter.

The method may involve passively monitoring data in the first and second directions.

The method may further involve signaling an operator in response to the bandwidth anomaly signal.

The method may further involve controlling at least one of the transmission and reception of data from the network in response to the bandwidth anomaly signal.

The first and/or second traffic waveforms may represent a statistical measure of first and second time distributions respectively of data volume in first and second directions.

In accordance with another aspect of the invention, there is provided an apparatus for detecting bandwidth anomalies in a data communication system. The apparatus includes provisions for receiving a first traffic waveform representing a time distribution of data volume in a first direction in the data communication system in a first period of time, provisions for producing a correlation value representing a correlation of the first traffic waveform with a reference waveform, and provisions for producing a bandwidth anomaly signal when the correlation value satisfies a criterion.

In accordance with another aspect of the invention, there is provided a computer readable medium encoded with codes for directing a processor circuit to detect bandwidth anomalies in a data communication system, by causing the processor circuit to receive a first traffic waveform representing a time distribution of data volume in a first direction in the data communication system in a first period of time, produce a correlation value representing a correlation of the first traffic waveform with a reference waveform, and produce a bandwidth anomaly signal when the correlation value satisfies a criterion.

In accordance with another aspect of the invention, there is provided a computer readable signal encoded with codes for directing a processor circuit to detect bandwidth anomalies in a data communication network, by causing the processor circuit to receive a first traffic waveform representing a time distribution of data volume in a first direction in the data communication system in a first period of time, produce a correlation value representing a correlation of the first traffic waveform with a reference waveform, and produce a bandwidth anomaly signal when the correlation value satisfies a criterion.

In accordance with another aspect of the invention, there is provided an apparatus for detecting bandwidth anomalies in a data communication system. The apparatus includes a processor circuit configured to receive a first traffic waveform representing a time distribution of data volume in a first direction in the data communication system in a first period of time, produce a correlation value representing a correlation of the first traffic waveform with a reference waveform, and produce a bandwidth anomaly signal when the correlation value satisfies a criterion.

The processor circuit may be configured to determine whether the correlation value is less than a reference value and to produce the bandwidth anomaly signal when the correlation value is less than the reference value.

The apparatus may further include a first traffic waveform generator operable to receive a first set of traffic measurement values and to produce the first traffic waveform in response thereto. The first traffic generator may be configured to produce the first traffic waveform by subjecting the first set of traffic measurement values to a Discrete Wavelet Transform. The first traffic waveform generator may be configured to use Haar wavelet filter coefficients in the Discrete Wavelet Transform and it may be configured to cause the Discrete Wavelet Transform to produce a first component representing the first traffic waveform.

The processor circuit may be configured to produce the correlation value by correlating the first component with the reference waveform.

The processor circuit may be configured to implement the first traffic waveform generator.

The apparatus may further include a communication interface operable to monitor data in the first direction and to produce the first set of traffic measurement values in response thereto. The communication interface may produce values representing a property of an Ethernet statistics group in a remote monitoring protocol. The processor circuit may be configured to communicate with the communication interface to receive the values representing a property of an Ethernet statistics group, the values representing the first set of traffic measurement values.

The communication interface may include at least one of a packet counter and an octet counter operable to count a corresponding one of packets and octets of data in the first direction. The processor circuit may be configured to communicate with the communication interface to receive values produced by at least one of the packet counter and the octet counter, the values representing the first set of network traffic measurement values.

The processor circuit may be configured to implement the communication interface.

The apparatus may further include a passive monitor operable to passively monitor data in the first direction and to provide a copy of the data in the first direction to the communication interface.

The apparatus may be operable to transmit and receive data from a data communication system and may include a signaling device for signaling an operator in response to the bandwidth anomaly signal.

The apparatus may include a communication control device for controlling at least one of the transmission and reception of data from the network in response to the bandwidth anomaly signal.

The processor circuit may be configured to receive a second traffic waveform representing a time distribution of data volume, or a statistical measure thereof, in a second direction in the data communication network in a second period of time, and use the second traffic waveform as the reference waveform to produce the correlation value.

The apparatus may further include a traffic waveform generator operable to receive first and second sets of traffic measurement values and to produce the first and second traffic waveforms in response thereto or may employ first and second separate traffic waveform generators to produce the first and second traffic waveforms in response to the first and second sets of traffic measurement values respectively.

The traffic waveform generator(s) may be configured to produce the first and second traffic waveforms by subjecting the first and second sets of traffic measurement values respectively, to a Discrete Wavelet Transform.

The traffic waveform generator(s) may be configured to use Haar wavelet filter values in the Discrete Wavelet Transform and may be configured to cause the Discrete Wavelet Transform to produce a first component, representing the first traffic waveform and a second component representing the second traffic waveform.

The processor circuit may be configured to produce the correlation value by correlating the first and second components.

The processor circuit may be configured to implement the traffic waveform generator(s).

The apparatus may further include a communication interface operable to monitor data in the first and second directions and to produce the first and second sets of traffic measurement values respectively in response thereto.

The communication interface may produce values representing a property of an Ethernet statistics group in a remote monitoring protocol, for each of the first and second directions. The processor circuit may be configured to communicate with the communication interface to receive the values representing a property of an Ethernet statistics group, for each direction, the values representing the first and second sets of traffic measurement values respectively.

The communication interface may include at least one of a packet counter and an octet counter operable to count a corresponding one of packets and octets of data for each of the first and second directions. The processor circuit may be configured to communicate with the communication interface to receive values produced by at least one of the packet counter and the octet counter, the values representing the first and second sets of traffic measurement values.

The processor circuit may be configured to implement the communication interface.

The apparatus may further include a passive monitor operable to passively monitor data in the first and second directions and to provide copies of the data to the communication interface.

The apparatus may include a signaling device for signaling an operator in response to the bandwidth anomaly signal.

The apparatus may include a communication control device for controlling at least one of the transmission and reception of data from the network in response to the bandwidth anomaly signal.

In a sense, the invention provides a way of interpreting the data traffic as a data traffic waveform and detecting the onset of abnormal levels of transmitted data traffic by analyzing characteristics of the data traffic waveform. In one embodiment, a data traffic waveform may be sampled by recording the frequency and volume, that is, the number of units of data traffic that are seen at a particular location on a full duplex computer network link in each of a plurality of time periods.

Embodiments of the invention may be used to detect and subsequently neutralize a DDoS attack by blocking outbound communications of systems producing the malicious network traffic, preferably at the level of the individual computers infected with the DDoS agents. The method and apparatus herein may be employed to monitor bandwidth use at or near the edge of the network close to potential DDoS agents on source computers. Apparatus and methods according to the invention may be incorporated as a component of department-level Ethernet switches, routers or personal firewall hardware and firewall software, for example.

### BRIEF DESCRIPTION OF THE DRAWINGS

The foregoing and other aspects of the invention will become more apparent from the following description of specific embodiments thereof and the accompanying drawings which illustrate, by way of example only, the principles of the invention. In the drawings:

FIG. 1 is a schematic diagram of a data communication system employing a bandwidth anomaly detector according to one embodiment of the invention;

FIG. 2 is a graphical representation of a first set of traffic measurement values representing data traffic in a first direction in the data communication system;

FIG. 3 is a block diagram of a network subsystem of the communications system shown in FIG. 1;

FIG. 4 is a graph representing first and second waveforms representing a time distribution of data volume in first and second directions on the data communication system of FIG. 1 for data that is not associated with a bandwidth anomaly;

FIG. 5 is a block diagram of a processor circuit according to one embodiment of the invention and an alternative embodiment thereof;

FIG. 6 is a graph representing first and second waveforms representing a time distribution of data volume in first and second directions on the data communication system of FIG. 1 for data that is associated with a bandwidth anomaly; and

FIGS. 7 and 8 are flow diagrams of a method executed by the processor circuit shown in FIG. 5.

### DETAILED DESCRIPTION

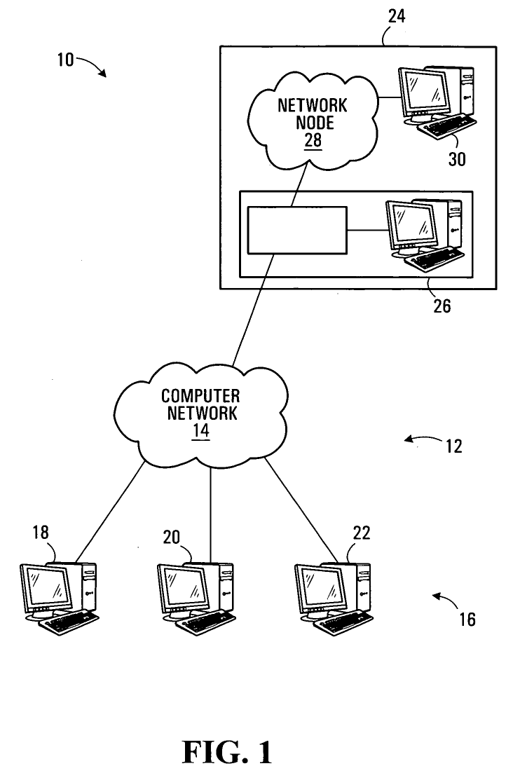

Referring to FIG. 1, a system according to a first embodiment of the invention is shown generally at 10. The system includes a network of computers shown generally at 12 comprising a data communication system 14 such as an Intranet or Internet, and a plurality of nodes shown generally at 16 including networked devices such as, for example, a personal computer 18, a first server computer 20, a second server computer 22 and a network sub-system shown at 24. In this embodiment, the network subsystem includes a bandwidth anomaly detector shown generally at 26 and a network node 28 which may include a sub-network and/or any of a plurality of devices which would normally be connected to a computer network. Such devices may include, but are not limited to server computers, client computers, routers, bridges, multi-port bridges (Ethernet switches), hubs, ATM switches, and wireless access points for example. The data communication system 14 may be local to a site thereby representing a Local Area Network (LAN) or may be global, for example, such as the Internet.

During the normal operation of the system 10 the networked devices 16 communicate with one another. For example, the client computer 18 may communicate with the server computers 20 or 22 or other client computers connected to the data communication system 14. In all cases, communication between the networked devices 16 involves the use of several data transfer protocols. These protocols may be classified, for example, according to the OSI 7-layer model of network protocols. The protocols may include protocols from the TCP/IP protocol suite, for example.

A typical interaction between a client computer 18 and a server computer 30 such as a World Wide Web server associated with the network sub-system 24 involves the client computer 18 initiating a protocol connection with the server computer 30, i.e., in the transmit and receive directions relative to the server computer 30. This is followed by a plurality of data packet transfers between the client computer 18 and the server computer 30. Eventually the protocol connection is terminated by either the client computer 18 or the server computer 30. A plurality of such protocol connections between a plurality of client computers and a plurality of server computers results in an aggregation of packet transfers on the network. A detailed description of this process for the TCP/IP protocol suite is found in Stallings High-speed Networks: TCP/IP and ATM Design Principles, Prentice-Hall, 1998. In general, each networked device transmits data packets to the data communication system 14 for transmission to another networked device and each networked device is operable to receive from the data communication system 14 data packets originating at another networked device.

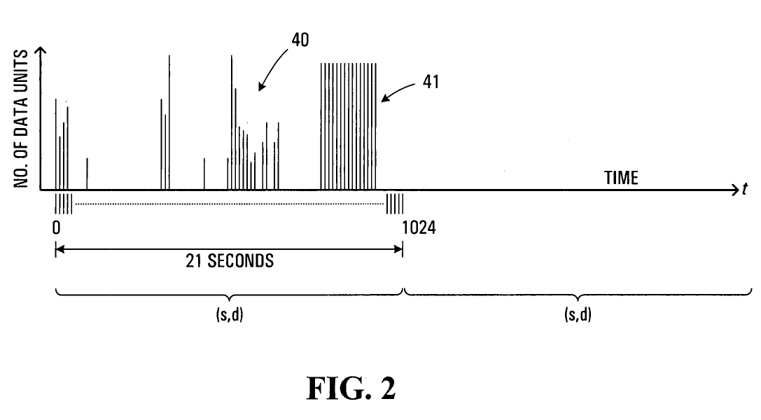

Normal communications conducted by one networked device with another networked device on the data communication system 14 normally appears “bursty” in the transmit and receive directions. Bandwidth anomalies such as those which occur due to a Distributed Denial of Service Attack appear as non-burst, or solid data transmissions. An example of normal communications between the client computer 18 and the server 30, in the transmit direction, is shown generally at 40 in FIG. 2. Similar activity would be observed in the receive direction, for normal data traffic. An example of data volume associated with a Denial of Service Attack in the transmit direction is shown generally at 41 in FIG. 2. Similar activity would not be observed in the receive direction.

Referring back to FIG. 1, in the embodiment shown, the bandwidth anomaly detector 26 is used to monitor data packets travelling in at least one direction relative to the network subsystem 24 and produces a bandwidth anomaly signal when a bandwidth anomaly such as caused by a distributed denial of service attack is detected in that direction. This bandwidth anomaly signal may be used to actuate a signaling device for signaling an operator and/or it may be used to actuate a communication control device for controlling at least one of the transmission and reception of data from the network in response to the bandwidth anomaly signal.

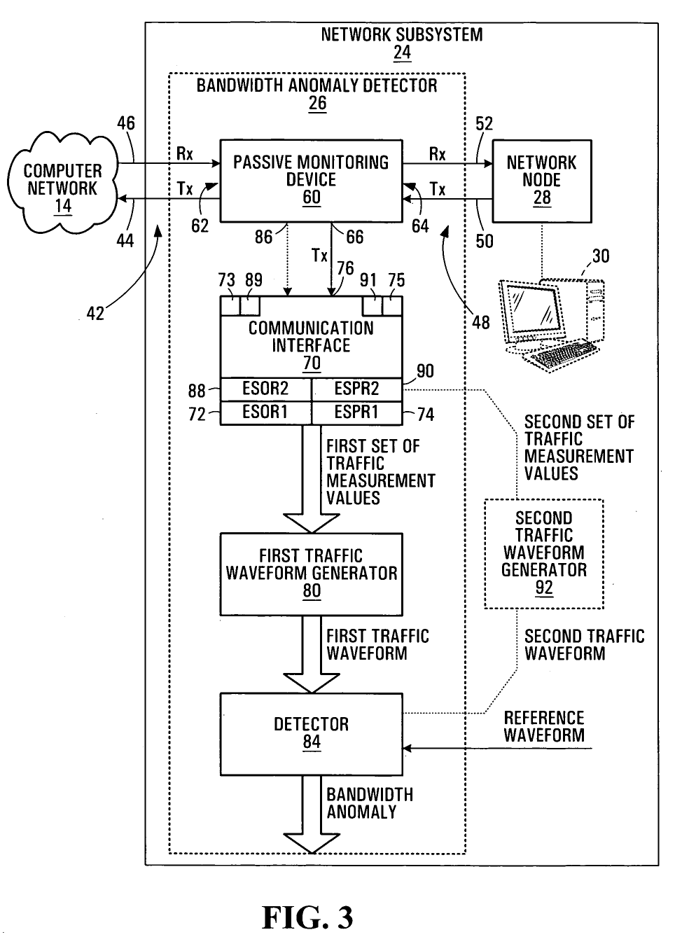

An embodiment of an exemplary bandwidth anomaly detector is shown at 26 in FIG. 3 and is depicted as a separate device in this embodiment, interposed between the data communication system 14 and the network node 28. The bandwidth anomaly detector 26 may be located anywhere in the data communication system 14 where it can sample data traffic being transmitted between any two networked devices. However, a benefit may be obtained when the bandwidth anomaly detector 26 is located at or near the edge of the network, for example with Ethernet switches in a department-level communications room, close to potential Distributed Denial of Service agents.

For explanatory purposes, a link 42 between the data communication system 14 and the bandwidth anomaly detector 26 is depicted as having a first transmit data line 44 and a first receive data line 46. Similarly, a second link 48 is provided between the bandwidth anomaly detector 26 and the network node 28 and includes a second transmit data line 50 and a second receive data line 52. The first receive data line 46 receives data from the data communication system 14 destined for the network node 28. The second transmit data line 50 carries data transmitted by the network node 28 destined for the data communication system 14.

In this embodiment, data travelling on the transmit data lines 44 and 50 is considered to be travelling in a first (transmit) direction on the network and data travelling on receive data lines 46 and 52 is considered to be travelling in a second (receive) direction.

The bandwidth anomaly detector 26 is shown as a separate device but may be incorporated into an apparatus which itself acts as a network node. For example, the bandwidth anomaly detector may be incorporated into a router, bridge, multi-port bridge, hub, wireless access point, cable/DSL modem, firewall, or ATM switch, for example.

In this embodiment, the bandwidth anomaly detector 26 includes a passive monitoring device 60 having network side link connections 62 for connection to the first link 42 and having node side connections 64 for connecting to the network node 28. The passive monitoring device 60 also has at least one output, in this embodiment output 66, which is operable to supply a copy of each data unit appearing on the transmit line 50. The passive monitoring device 60 simply taps off a copy of the data in at least one direction, in this instance the transmit direction. In general, the passive monitoring device 60 may be said to passively monitor data in the first direction and to make a copy of the data in the first direction available to another device. A typical passive monitoring device that may be used in this application is provided by Net Optics Corporation of Sunnyvale, Calif.

The bandwidth anomaly detector 26 further includes a communication interface 70 which may include a network interface chip such as an Ethernet interface chip, switch processor, or security processor, for example. Alternatively, the communication interface 70 may be implemented by other components including discrete logic circuits and/or processor circuits, for example.

In this embodiment, the communication interface 70 includes an Ethernet interface chip having registers operable to provide values in accordance with a property of an Ethernet statistics group of an Ethernet remote monitoring protocol standard such as set forth in the Internet Engineering Task Force RFC #3144. In particular, the communication interface 70 includes at least one of an octets register 72 and a packets register 74 of an octet counter 73 and a packet counter 75. The communications interface 70 has an input 76 in communication with the output 66 of the passive monitoring device 60 to receive copies of the data units on the transmit data line 50 and keeps a count of these data units and determines from the data units the number of octets and the number of packets associated with such data units over a specified period of time which will be referred to herein as a sample time. In this embodiment, the communication interface 70 is set to count the number of octets and packets on the transmit data line 50 during successive 1/1024 second intervals and at the end of each interval, load the octets register 72 and the packets register 74 with associated count values. Thus, each 1/1024 second a new count value is available in the octets register 72 and in the packets register 74. Thus, the communications interface 70 serves to monitor data in a first direction by sampling data on the transmit line to produce traffic measurement values. A plurality of these traffic measurement values gathered over a period of time or window, such as 120 seconds, for example, may be referred to as a first set of traffic measurement values.

The bandwidth anomaly detector 26 further comprises a traffic waveform generator 80 operable to receive the first set of traffic measurement values and to produce a first traffic waveform representing a time distribution of data volume in the transmit direction in response thereto. The first traffic waveform generator 80 is configured to produce the first traffic waveform by subjecting the first set of traffic measurement values to a Discrete Wavelet Transform to perform a wavelet analysis on this first set of traffic measurement values.

Wavelet analysis allows for the detection of abrupt changes in frequency across a range of time scales. The Discrete Wavelet Transform involves the application of a series of successive low- and high-pass filtering operations using a selected wavelet function to produce approximation and detail components of the original data traffic signal. One example wavelet function which may be used for this purpose in the present invention is the Haar Wavelet. Commercial software packages including the MATLAB Wavelet Toolbox and User's Guide provide utilities for general purpose analysis of signals with the Discrete Wavelet Transform.

Various different coefficients may be used in the Discrete Wavelet Transform and it has been found that in this embodiment using Haar wavelet filter coefficients in the Discrete Wavelet Transform causes the first traffic waveform generator 80 to produce smooth and detail waveform components of the first set of traffic measurement values. In this embodiment, only the smooth component is of interest and the smooth component represents the first traffic waveform.

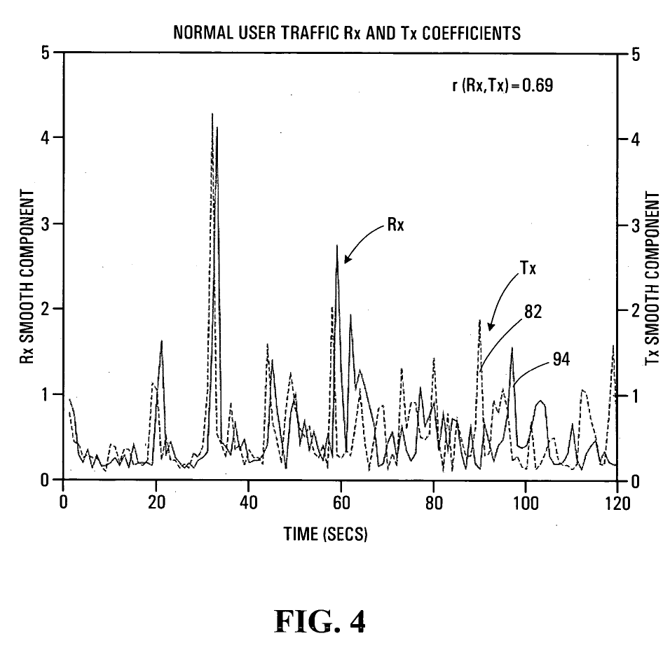

Referring to FIG. 4, the smooth component is seen as a plot of an amplitude value versus time as shown in broken outline at 82 over a 120 second time interval. The first traffic waveform generator 80 shown in FIG. 3 represents the first traffic waveform as a plurality of amplitude values associated with respective times in the 120 second window in which samples are taken, to produce the first set of traffic measurement values. Thus, the first traffic waveform represents a time distribution of data volume in a first direction in the data communication system in a first period of time.

Referring back to FIG. 3, the bandwidth anomaly detector 26 further includes a detector for detecting bandwidth anomalies 84. This detector 26 is operable to receive the first traffic waveform and a reference waveform and produces a correlation value representing a correlation of the first traffic waveform with the reference waveform. When the correlation value satisfies a criterion, the bandwidth anomaly signal is produced.

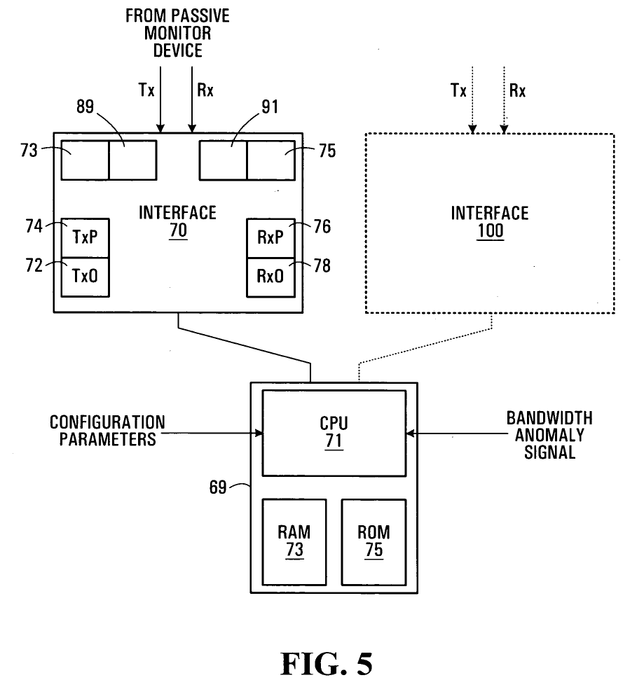

Referring to FIGS. 3 and 5, the detector 84 may be implemented in a processor circuit 69 which may be part of a personal computer system, for example. The processor circuit may include a CPU 71, RAM 73, and ROM 75 and may further include the communication interface 70, for example. Alternatively, the processor circuit 69 may be that of a switch, router, bridge or any other apparatus connectable to the data communication system. The same processor circuit 69 that implements the detector 84 may be used to implement the first traffic waveform generator 80 and the communication interface 70. Alternatively, any combination of the communication interface 70, first traffic waveform generator 80 and detector 84 may be implemented using a wide variety of different processor circuit combinations. The processor circuit 69 implementing the detector 84 may be configured to determine whether the correlation value it produces is less than a reference value and to produce the bandwidth anomaly signal when the correlation value is less than this reference value. Additional criteria for producing the bandwidth anomaly signal may be employed, such as determining whether the correlation value is sustained at a value less than the reference value for a period of time, or whether a number of occurrences of a correlation value less than the reference value happen over a period of time, for example.

The reference waveform used for correlation with the first traffic waveform may be a pre-stored waveform or may alternatively be a second traffic waveform produced in response to a second set of traffic measurement values produced by monitoring data units in a second direction such as on the receive data line 46. In this instance, the passive monitoring device 60 may be configured to have a second output 86 operable to provide copies of data units appearing on the receive data line 46 to the communication interface 70. In addition, the communication interface 70 may be configured with a second Ethernet statistics octet register 88 and a second Ethernet statistics packet register 90 of an octet counter 89 and a packet counter 91 for holding count values representing the number of octets and the number of packets, respectively, on the receive data line 46 in a given 1/1024^{th} of a second, that is, during the same time period during which octets and packets in the transmit direction are counted. Alternatively, the communication interface 70 may be implemented in a separate chip or processor circuit, for example. The traffic measurement values produced by monitoring the receive data line 46 may be accumulated into a second set of traffic measurement values and this second set may be provided to a second traffic waveform generator 92, the same as the first traffic waveform generator 80, to produce a second traffic waveform as shown at 94 in FIG. 4, which acts as the reference waveform to which the first traffic waveform is correlated. Alternatively, the first and second sets of traffic measurement values can be accumulated over generally the same time period, stored and supplied to the first waveform generator, in succession, to produce the first and second traffic waveforms (i.e., the first waveform generator may be multiplexed).

Given the first and second traffic waveforms, the detector 84 may produce a correlation value such as the value 0.69 shown in FIG. 4 representing the correlation of the first and second traffic waveforms and more particularly, the correlation of the transmit waveform with the receive waveform. The detector may then determine whether this correlation value 0.69 is above a predefined value such as 0.6 and, if so, set the bandwidth anomaly signal inactive to indicate that there is a good correlation between transmit and receive data volume over the same time period and therefore no bandwidth anomaly is occurring.

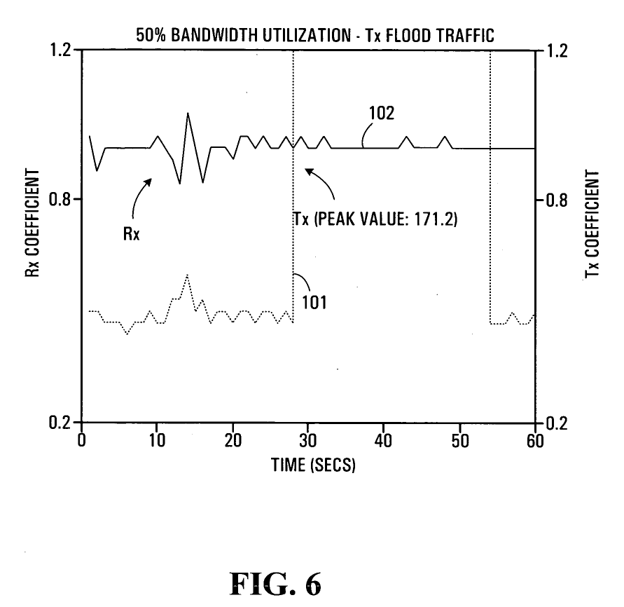

Referring to FIG. 6, if, however, the first and second traffic waveforms are as depicted at 101 and 102, respectively, for example, the detector may produce a correlation value such as 0.12 and the apparatus may determine that this correlation value is less than the 0.6 pre-defined value and therefore may set the bandwidth anomaly signal active to indicate that a correlation consistent with a denial of service attack, for example, has been found. Referring back to FIG. 3, the bandwidth anomaly signal may be used to interrupt a processor circuit in a switch or the network node 28, for example, to cause the switch or network node 28 to be denied access to the data communication system 14 to stop the denial of service attack. Alternatively or in addition, the bandwidth anomaly signal may be provided to an operator by way of an alarm, blinking light, audible signal or any other stimulus recognizable by an operator to indicate to the operator that a bandwidth anomaly and, in particular, in this case a denial of service attack has occurred.

Referring to FIG. 5, an alternative implementation of the system described herein may be implemented with a different interface 100. This interface 100 may simply provide a path to the processor circuit 69, for the data units received from the passive monitoring device 60 (shown in FIG. 3) and the processor circuit 69 itself may be used to perform counting functions to count the number of packets and/or octets appearing on either or both the transmit and receive lines in a given sample interval. Code for directing the processor circuit 69 to carry out these functions may be provided to the processor circuit as computer readable instructions supplied on a computer-readable medium such as an EPROM, which may form part of the ROM 75, or may be supplied to the processor circuit 69 on a compact or floppy disk, for example and stored in programmable ROM which may also form part of the ROM 75. Alternatively or in addition, the codes for directing the processor circuit 69 to carry out functions according to an embodiment of the invention may be supplied to the processor circuit by way of a computer readable signal encoded with such codes, such as may be provided by reading data packets received on the receive line, for example.

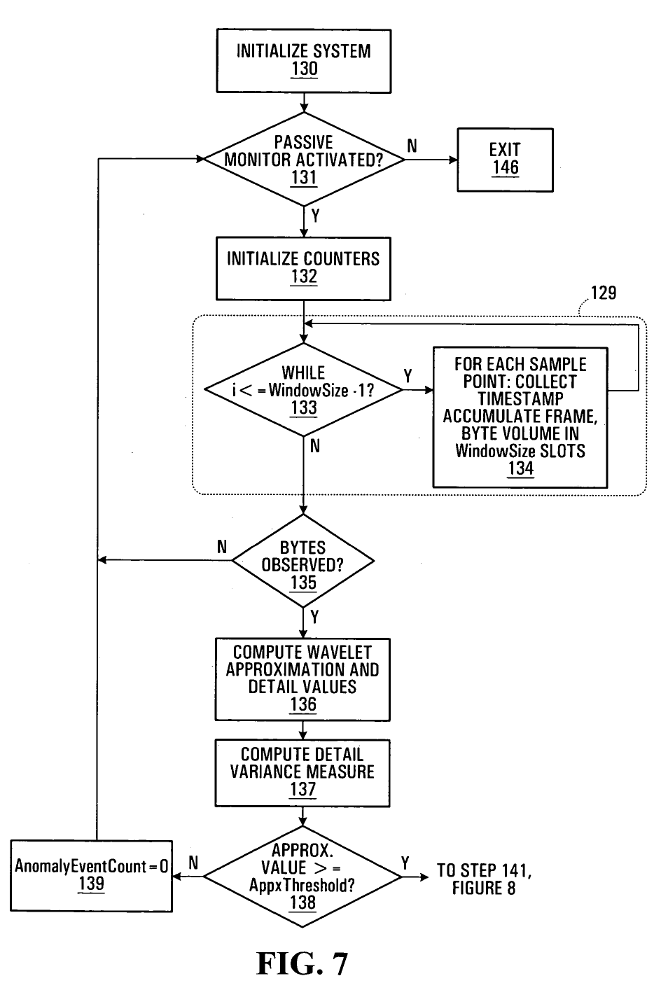

A flowchart containing blocks indicative of blocks of code that may be used to implement this alternative embodiment of the invention is depicted in FIG. 7. The actual code used to implement the functionality indicated in any given block may be written in the C, C++ and/or assembler code, for example.

In this embodiment, the processor circuit 69 is first directed by block 130 to initialize various counters and registers including octet and packet count registers, arrays, indices, status indicators, flags, control registers. Block 131 then directs the processor circuit 69 to communicate with the passive monitoring device 60 to determine whether or not the passive monitoring device is operating to passively monitor packets on the transmit and receive lines. If it is not, the process is ended.

If the passive monitoring device 60 is operational, block 132 directs the processor circuit 69 to initialize counters.

Then block 129 directs the processor circuit 69 to fill first and second arrays with first and second sets of traffic measurement values. To do this, block 129 includes two main functional blocks which cooperate to implement a loop to fill the arrays. The first functional block 133 directs the processor circuit 69 to determine whether an index value i is less than or equal to a reference value calculated as a pre-defined value, WindowSize−1, where WindowSize refers to the number of elements in the first and second sets of traffic data. This value is desirably a power of 2. Ultimately, the WindowSize value represents the length of a period of acquisition of the first and second sets of traffic data.

Block 134 directs the processor circuit 69 to acquire and store in the first and second arrays current packet or octet counter values and associated timestamp values for the transmit and receive lines, increments the index i and returns the processor to block 133. Thus, the first and second arrays are arrays of pairs of numbers, the first number indicating a time interval to which the counter value relates and the second number indicating the counter value associated with that time. The first and second arrays may be referred to as first and second PacketVectors having a length of WindowSize.

Block 135 directs the processor circuit 69 to read the first and second arrays to determine whether all of the values in the arrays are zero. If so, the processor circuit is directed back to block 131 to determine whether the passive monitor is still activated and to re-start the gathering of count values.

Block 136 implements the waveform generator function described above and directs the processor circuit 69 to subject the first and second PacketVectors to wavelet analysis using the Discrete Wavelet Transform, to produce an approximation value and detail values for each of the transmit and receive directions. Approximation values represent high-scale, low-frequency components of data traffic measurements. High-scale refers to the “stretching” of the wavelet used to filter the signal so as to view the data traffic measurements over a longer time window. Detail values represent low-scale, high-frequency components of the input data traffic measurements. Low-scale refers to the “compressing” of the wavelet used to filter the data traffic measurements so as to view the data traffic measurements over a short time window.

In this embodiment block 137 then directs the processor circuit 69 to compute a variance measure for the current and prior detail values produced by the Discrete Wavelet Transform. One variance measure which may be used is the Standard Deviation, for example. The variance measure is a single number representing the standard deviation of a set of detail values.

Block 138 then directs the processor circuit 69 to compare the approximation value produced at block 136 with an AppxThreshold value representing an upper bound of the approximation value for normal data traffic on the transmit line.

If the approximation value exceeds the AppxThreshold, block 139 directs the processor circuit 69 to set an AnomalyEventCount value to 0.

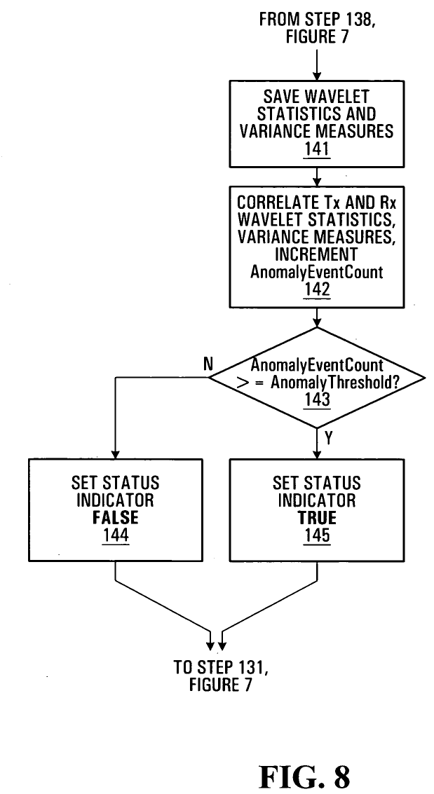

Referring to FIG. 8, if the approximation value is greater than or equal to the AppxThreshold value, block 141 directs the processor circuit 69 to store the approximation value and the detail variance measure.

The storage of approximation values and detail variance measure values has the effect of accumulating these values or representations of these values. Sets of these values represent first and second traffic waveforms representing first and second statistical measures of time distributions of data volume in first and second directions in the data communication system in respective periods of time.

Block 142 directs the processor circuit 69 to increment the AnomalyEventCount value when the approximation value is greater than or equal to the AppxThreshold value. Block 142 also directs the processor circuit 69 to correlate with each other, the stored approximation values for the first and second directions to produce a first correlation value (r1) and to correlate with each other the stored variance values for the first and second directions to produce a second correlation value (r2). Examples of correlation value calculations are given in Snedecor, G. W. and W. G. Cochran (1967) Statistical Methods. When r1 and/or r2 satisfy respective criterion such as when one or the other or both are below a reference correlation value or values, the AnomalyEventCount value is incremented. Other criteria such as when the ratio of the absolute value of the difference between transmit line approximation and variance values from time t₁ to time t₂ to the absolute value of the difference between receive line approximation and variance values from t₁ to time t₂, maintains a stable value, may be used to indicate whether the AnomalyEventCount value should be incremented. Such stable value may be user defined or based on historical measurements during periods when a normal data traffic waveform is present. The degree of correlation between the transmit line data traffic and the receive line data traffic may alternatively, for example, be measured by a fuzzy set membership function as described in The Fuzzy Systems Handbook (Second Edition) by Earl Cox.

Elevated, and relatively constant variance measures of the detail values derived from the data traffic on the transmit line are indicative of abnormal bandwidth consumption while fluctuating values of variance associated with the detail values are indicative of normal data traffic. The fluctuation of the approximation and detail values derived from the transmit line data generally positively correlate with the fluctuation of the approximation and detail values derived for data measured on the receive line over substantially the same time interval.

In correlating the fluctuations of the approximation and detail values for the transmit and receive lines, it is not necessary that the transmit and receive data be measured at identical times. Since the approximation and detail values are smoothed values, correlations can be detected even if the data is not measured simultaneously. However, data count value samples for the transmit and receive lines should be taken at times which are close enough to one another to detect correlations in these smoothed values during normal network traffic activity.

After block 142, block 143 directs the processor circuit 69 to determine whether the AnomalyEventCount value is greater than or equal to an anomaly threshold value associated with a specific type of bandwidth anomaly sought to be detected. In this embodiment assume a denial of service type of bandwidth anomaly is sought to be detected and thus the threshold value used is a DoSThreshold value. Thus, in this embodiment if the AnomalyEventCount value is greater than or equal to the DoSThreshold value, block 145 directs the processor circuit to set a status indicator such as a flag or signal control register to a true or active value to cause the bandwidth anomaly signal to be produced. The signal control register may be a register operable to control the state of a digital signal representing the bandwidth anomaly signal, for example, or it may initiate the invocation of a routine in the processor circuit that causes the processor circuit to send a bandwidth anomaly message to a control computer or processor circuit, such as a switch control circuit. The control computer may signal the operator or block the denial of service attack by interrupting data flow or reducing available bandwidth on the transmit or receive lines, for example.

If the AnomalyEventCount value is not greater than or equal to the DoSThreshold value, in this embodiment the processor circuit 69 is directed to block 144 which causes it to set the status indicator to a false or inactive value so that the bandwidth anomaly signal will not be produced. The threshold values may be defined by an operator or may be based on an average value derived from measured normal data traffic waveforms over a specified time interval (seconds, minutes, hours, etc.). For example, an operator may set the value of AppxThreshold value to 6.0, a detail variance threshold to 0.30 and the AnomalyThreshold value at 5 events for the detection of transmit line bandwidth abuse associated with a denial of service attack. All operator configurable parameters such as the AppxThreshold value and the DosThreshold value, for example, may be received at the CPU 71 shown in FIG. 5 via messages sent by a host computer or user interface executed by the CPU 71, itself, for example. Separate tests using separate values for AppxThreshold, detail variance threshold and AnomalyThreshold may be employed to detect specific types of bandwidth anomalies, the denial of service type of bandwidth anomaly being only one of a plurality of bandwidth anomaly types that can be detected.

While specific embodiments of the invention have been described and illustrated, such embodiments should be considered illustrative of the invention only and not as limiting the invention as construed in accordance with the accompanying claims.

What is claimed is:

1. A method of detecting bandwidth anomalies in a data communication system, the method comprising:
receiving a first traffic waveform representing a time distribution of data volume in a first direction in said data communication system in a first period of time;
producing a correlation value representing a correlation of said first traffic waveform with a reference waveform; and
producing a bandwidth anomaly signal when said correlation value satisfies a criterion.

2. The method of claim 1 wherein producing said bandwidth anomaly signal comprises producing said denial of service attack signal when said correlation value is less than a reference value.

3. The method of claim 2 wherein producing said bandwidth anomaly signal comprises determining whether said correlation value is less than said reference value.

4. The method of claim 1 further comprising receiving a second traffic waveform representing a time distribution of data volume in a second direction on said data communication system in a second period of time, and using said second traffic waveform as said reference waveform to produce said correlation value.

5. The method of claim 1 further comprising generating said first traffic waveform in response to a first set of traffic measurement values.

6. The method of claim 5 wherein generating said first traffic waveform comprises subjecting said first set of traffic measurement values to a Discrete Wavelet Transform.

7. The method of claim 6 wherein subjecting said first set of traffic measurement values to said Discrete Wavelet Transform comprises using Haar wavelet filter coefficients in said Discrete Wavelet Transform.

8. The method of claim 6 wherein generating said first traffic waveform comprises causing said Discrete Wavelet Transform to produce a first component, said first component representing said first traffic waveform.

9. The method of claim 8 wherein producing said correlation value comprises correlating said first component with said reference waveform.

10. The method of claim 8 further comprising using a processor circuit to generate said first traffic waveform and to correlate said first traffic waveform with said reference waveform.

11. The method of claim 1 wherein said first traffic waveform represents a statistical measure of a time distribution of data volume in said first direction.

12. The method of claim 5 further comprising monitoring data in said first direction and producing said first set of traffic measurement values in response thereto.

13. The method of claim 12 wherein producing said first set of traffic measurement values comprises producing values representing a property of an Ethernet statistics group in a remote monitoring protocol.

14. The method of claim 13 further comprising causing a processor circuit operable to produce said first traffic waveform to communicate with a communication interface to receive said values representing said property of an Ethernet statistics group.

15. The method of claim 12 wherein monitoring said data in said first direction comprises at least one of: counting packets and counting octets, in said first direction.

16. The method of claim 15 further comprising causing a processor circuit operable to produce said first traffic waveform to communicate with at least one of a packet counter and an octet counter to receive values representing said first set of traffic measurement values.

17. The method of claim 16 further comprising causing said processor circuit to implement at least one of said packet counter and said octet counter.

18. The method of claim 12 further comprising passively monitoring said data in said first direction.

19. A data communication method comprising transmitting and receiving data from a data communication system, the data communication system method of claim 12 and further comprising signaling an operator in response to said bandwidth anomaly signal.

20. A data communication method comprising transmitting and receiving data from a data communication system, the data communication system method of claim 12 and further comprising controlling at least one of transmission and reception of data from said data communication system in response to said bandwidth anomaly signal.

21. The method of claim 4 further comprising generating said first and second traffic waveforms in response to first and second sets of traffic measurement values, representing traffic in said first and second directions on said data communication system, respectively.

22. The method of claim 21 wherein receiving said first and second traffic waveforms comprises receiving first and second waveforms representing first and second statistical measures of first and second time distributions respectively of data volume in first and second directions in said data communications system.

23. The method of claim 21 wherein generating said first and second traffic waveforms comprises subjecting said first and second sets of traffic measurement values respectively, to a Discrete Wavelet Transform.

24. The method of claim 23 wherein subjecting said first and second sets of traffic measurement values to said Discrete Wavelet Transform comprises using Haar wavelet filter coefficients in said Discrete Wavelet Transform.

25. The method of claim 23 further comprising causing said Discrete Wavelet Transform to produce a first component, representing said first traffic waveform and a second component representing said second traffic waveform.

26. The method of claim 25 wherein producing said correlation value comprises correlating said first and second components.

27. The method of claim 25 further comprising implementing a traffic waveform generator in a processor circuit used to produce said correlation value.

28. The method of claim 21 further comprising monitoring data in said first and second directions and producing said first and second sets of traffic measurement values respectively in response thereto.

29. The method of claim 28 wherein producing said first and second sets of traffic measurement values comprises producing values representing a property of an Ethernet statistics group in a remote monitoring protocol, for each of said first and second directions.

30. The method of claim 29 further comprising causing a processor circuit operable to produce said first and second traffic waveforms to communicate with a communication interface to receive said values representing a property of an Ethernet statistics group.

31. The method of claim 28 wherein monitoring said data comprises at least one of: packet counters and octet counters in each of said first and second directions.

32. The method of claim 28 further comprising causing a processor circuit operable to produce said first and second traffic waveforms to communicate with at least one of a packet counter and an octet counter to receive values representing said first and second sets of traffic measurement values.

33. The method of claim 32 further comprising causing said processor circuit to implement at least one of said packet counter and said octet counter.

34. The method of claim 28 further comprising passively monitoring said data in said first and second directions.

35. A data communication method comprising transmitting and receiving data from a data communication system, the data communication method of claim 1 and further comprising signaling an operator in response to said bandwidth anomaly signal.

36. A data communication method comprising transmitting and receiving data from a data communication system, the data communication method of claim 1 and further comprising controlling at least one of the transmission and reception of data from said data communication system in response to said bandwidth anomaly signal.

37. An apparatus for detecting bandwidth anomalies in a data communication system, the apparatus comprising:
means for receiving a first traffic waveform representing a time distribution of data volume in a first direction in said data communication system in a first period of time;
means for producing a correlation value representing a correlation of said first traffic waveform with a reference waveform; and
means for producing a bandwidth anomaly signal when said correlation value satisfies a criterion.

38. A computer readable medium encoded with codes for directing a processor circuit to detect bandwidth anomalies in a data communication system, by:
receiving a first traffic waveform representing a time distribution of data volume in a first direction in said data communication system in a first period of time;
producing a correlation value representing a correlation of said first traffic waveform with a reference waveform; and
producing a bandwidth anomaly signal when said correlation value satisfies a criterion.

39. A computer readable signal encoded with codes for directing a processor circuit to detect bandwidth anomalies in a data communication system, by:
receiving a first traffic waveform representing a time distribution of data volume in a first direction in said data communication system in a first period of time;
producing a correlation value representing a correlation of said first traffic waveform with a reference waveform; and
producing a bandwidth anomaly signal when said correlation value satisfies a criterion.

40. An apparatus for detecting bandwidth anomalies in a data communication system, the apparatus comprising:
a processor circuit configured to:
receive a first traffic waveform representing a time distribution of data volume in a first direction in said data communication system in a first period of time;
produce a correlation value representing a correlation of said first traffic waveform with a reference waveform; and
produce a bandwidth anomaly signal when said correlation value satisfies a criterion.

41. The apparatus of claim 40 wherein said processor circuit is configured to produce said bandwidth anomaly signal when said correlation value is less than a reference value.

42. The apparatus of claim 41 wherein said processor circuit is configured to determine whether said correlation value is less than said reference value.

43. The apparatus of claim 40 wherein said processor circuit is configured to receive a second traffic waveform representing a statistical measure of a time distribution of data volume in a second direction on said data communication system in a second period of time, and use said second traffic waveform as said reference waveform to produce said correlation value.

44. The apparatus of claim 40 further comprising a first traffic waveform generator operable to receive a first set of traffic measurement values and to produce said first traffic waveform in response thereto.

45. The apparatus of claim 44 wherein said first traffic waveform generator is configured to produce said first traffic waveform by subjecting said first set of traffic measurement values to a Discrete Wavelet Transform.

46. The apparatus of claim 45 wherein said first traffic waveform generator is configured to use Haar wavelet filter coefficients in said Discrete Wavelet Transform.

47. The apparatus of claim 45 wherein said first traffic waveform generator is configured to cause said Discrete Wavelet Transform to produce a first component, said first component representing said first traffic waveform.

48. The apparatus of claim 47 wherein said processor circuit is configured to produce said correlation value by correlating said first component with said reference waveform.

49. The apparatus of claim 44 wherein said processor circuit is configured to implement said first traffic waveform generator.

50. The apparatus of claim 40 wherein said first traffic waveform represents a statistical measure of a time distribution of data volume in said first direction.

51. The apparatus of claim 44 further comprising a communication interface operable to monitor data in said first direction and to produce said first set of traffic measurement values in response thereto.

52. The apparatus of claim 51 wherein said communication interface produces values representing a property of an Ethernet statistics group in a remote monitoring protocol.

53. The apparatus of claim 52 wherein said processor circuit is configured to communicate with said communication interface to receive said values representing a property of an Ethernet statistics group, said values representing said first set of traffic measurement values.

54. The apparatus of claim 51 wherein said communication interface includes at least one of a packet counter and an octet counter operable to count a corresponding one of packets and octets of data in said first direction.

55. The apparatus of claim 54 wherein said processor circuit is configured to communicate with said communication interface to receive values produced by at least one of a said packet counter and said octet counter, said values representing said first set of traffic measurement values.

56. The apparatus of claim 55 wherein said processor circuit is configured to implement said communication interface.

57. The apparatus of claim 51 further comprising a passive monitor operable to passively monitor said data in said first direction and to provide a copy of said data in said first direction to said communication interface.

58. A data communication apparatus operable to transmit and receive data from a data communication system, the data communication apparatus comprising the apparatus of claim 51 and further comprising a signaling device for signaling an operator in response to said bandwidth anomaly signal.

59. A data communication apparatus operable to transmit and receive data from a data communication system, the data communication apparatus comprising the apparatus of claim 51 and further comprising a communication control device for controlling at least one of the transmission and reception of data from said data communication system in response to said bandwidth anomaly signal.

60. The apparatus of claim 43 further comprising a traffic waveform generator operable to receive said first and second sets of traffic measurement values and to produce said first and second traffic waveforms in response thereto.

61. The apparatus of claim 60 wherein said processor is configured to receive first and second traffic waveforms representing first and second statistical measures of first and second time distributions respectively of data volume in first and second directions in said data communications system.

62. The apparatus of claim 60 wherein said traffic waveform generator is configured to produce said first and second traffic waveforms by subjecting said first and second sets of traffic measurement values respectively, to a Discrete Wavelet Transform.

63. The apparatus of claim 62 wherein said traffic waveform generator is configured to use Haar wavelet filter coefficients in said Discrete Wavelet Transform.

64. The apparatus of claim 62 wherein said traffic waveform generator is configured to cause said Discrete Wavelet Transform to produce a first component, representing said first traffic waveform and a second component representing said second traffic waveform.

65. The apparatus of claim 64 wherein said processor circuit is configured to produce said correlation value by correlating said first and second components.

66. The apparatus of claim 64 wherein said processor circuit is configured to implement said traffic waveform generator.

67. The apparatus of claim 60 further comprising a communication interface operable to monitor data in said first and second directions and to produce said first and second sets of traffic measurement values respectively in response thereto.

68. The apparatus of claim 67 wherein said communication interface produces values representing a property of an Ethernet statistics group in a remote monitoring protocol, for each of said first and second directions.

69. The apparatus of claim 68 wherein said processor circuit is configured to communicate with said communication interface to receive said values representing a property of an Ethernet statistics group, for each of said first and second directions, said values representing said first and second sets of traffic measurement values respectively.

70. The apparatus of claim 67 wherein said communication interface includes at least one of a packet counter and an octet counter operable to count a corresponding one of packets and octets of data for each of said first and second directions.

71. The apparatus of claim 67 wherein said processor circuit is configured to communicate with said communication interface to receive values produced by at least one of said packet counter and said octet counter, said values representing said first and second sets of traffic measurement values.

72. The apparatus of claim 67 wherein said processor circuit is configured to implement said communication interface.

73. The apparatus of claim 67 further comprising a passive monitor operable to passively monitor said data in said first and second directions and to provide copies of said data to said communication interface.

74. A data communication apparatus operable to transmit and receive data from a data communication system, the data communication apparatus comprising the apparatus of claim 40 and further comprising a signaling device for signaling an operator in response to said bandwidth anomaly signal.

75. A data communication apparatus operable to transmit and receive data from a data communication system, the data communication apparatus comprising the apparatus of claim 40 and further comprising a communication control device for controlling at least one of the transmission and reception of data from said data communication system in response to said bandwidth anomaly signal.
